(19) United States
(12) Patent Application Publication
(10) Pub. No.: US 2017/0235888 A1
(43) Pub. Date: Aug. 17, 2017

(54) Systems and Methods for Creating Contextualized Summaries of Patient Notes from Electronic Medical Record Systems

(71) Applicant: Tellit Health, Inc., San Juan Capistrano, CA (US)

(72) Inventors: Fuad Rahman, San Juan Capistrano, CA (US); Panagiotes Karanikas, San Juan Capistrano, CA (US); Thomas D. Giles, San Diego, CA (US)

(73) Assignee: Tellit Health, Inc., San Juan Capistrano, CA (US)

(21) Appl. No.: 15/430,401

(22) Filed: Feb. 10, 2017

Related U.S. Application Data
(60) Provisional application No. 62/294,701, filed on Feb. 12, 2016.

(51) Int. Cl. G06F 19/00; G06F 17/27

(52) U.S. Cl. CPC G06F 19/322; G06F 17/2785; G06F 17/277

(57) ABSTRACT

A computer-implemented method includes: (1) receiving at least one patient note from an electronic medical record (EMR) system as a source text narrative; (2) deriving lexical chains corresponding to themes in the source text narrative; (3) scoring the lexical chains with respect to a medical taxonomy to identify higher scoring lexical chains among the lexical chains; (4) scoring sentences in the source text narrative with respect to the higher scoring lexical chains to identify higher scoring sentences among the sentences; and (5) creating a textual summary of the source text narrative from the higher scoring sentences.

### CROSS-REFERENCE TO RELATED APPLICATION

This application claims the benefit of U.S. Provisional Application No. 62/294,701, filed Feb. 12, 2016, the content of which is incorporated herein by reference in its entirety.

### TECHNICAL FIELD

This disclosure generally relates to the creation of contextualized summaries of patient notes from electronic medical record systems.

### BACKGROUND

Healthcare in the United States and worldwide is under increasing pressures—financial, population and disease-burden. Further, healthcare is experiencing a shift in medical paradigms, with healthcare being driven towards a more cost effective, consolidated, large population, one-size-fits-all approach, moving society away from traditional personalized care. Further, the amount and type of medical information that healthcare providers are dealing with—for example, patient medical history and physical information, laboratory results, imaging, and other digital and analog input signals like electrocardiogram signals, is voluminous, varied and of differing structure and format. Thus, doctors have the increasing burden of rising patient number coupled with progressively less time to spend with each patient and coupled with progressively more information; hence, doctors are increasingly dealing with more patients, more information, and less time.

Electronic medical record (EMR) (or electronic health record (EHR)) use is increasing in primary care practices, partially driven in the United States by the Health Information Technology for Economic and Clinical Health Act. In 2011, about 55% of physicians and about 68% of family physicians reported as using an EMR system. By 2013, about 78% of office-based physicians reported as adopting an EMR system. EMR systems have the potential to improve outcomes and quality of care, yield cost savings, and increase engagement of patients with their own healthcare. When successfully integrated into clinical practice, EMR systems can automate and streamline clinician workflows, narrowing the gap between information and action that can result in delayed or inadequate care. In recent years, EMR adoption has proceeded at an accelerated rate, fundamentally altering the way healthcare providers document, monitor, and share information. EMR systems, however, can present a challenge for physicians, in view of the voluminous medical information stored in such systems.

Within an EMR system, information can be captured in different ways: (1) entering data directly, including through use of templates; (2) scanning documents; (3) transcribing text reports created with dictation or speech recognition software; and (4) interfacing data from other information systems such as laboratory systems, radiology systems, blood pressure monitors, or electrocardiographs. Clinical data can be represented in structured and unstructured form. Structured data can be created through choices in data input devices including drop-down menus, check boxes, and pre-filled templates. This type of data is readily searchable and aggregated, can be analyzed and reported, and can be linked to other information resources. However, structured data is not always sufficient in allowing individualized assessment of a patient's EMR. Unstructured clinical data can be in the form of free text narratives, such as of the sort found in a patient's history of present illness. Healthcare provider and patient encounters are often recorded as free-form clinical or patient notes. Free text entries into a patient's EMR give the provider flexibility to document observations that are not supported or anticipated by constrained choices associated with structured data. However, with unstructured text narrative comes the challenge of finding relevant information quickly and efficiently so that healthcare providers can analyze the information and use it to improve patient care. For example, with a typical 5 day hospital stay, multiple doctors and nurses can attend to the same patient and enter overlapping text narratives on progress of treatment, so much so that on the fourth or fifth day, it can be difficult to assess the status of the patient from the text narratives.

It is against this background that a need arose to develop the embodiments described in this disclosure.

### SUMMARY

In some embodiments, a computer-implemented method includes: (1) receiving at least one patient note from an electronic medical record (EMR) system as a source text narrative; (2) deriving lexical chains corresponding to themes in the source text narrative; (3) scoring the lexical chains with respect to a medical taxonomy to identify higher scoring lexical chains among the lexical chains; (4) scoring sentences in the source text narrative with respect to the higher scoring lexical chains to identify higher scoring sentences among the sentences; and (5) creating a textual summary of the source text narrative from the higher scoring sentences.

In some embodiments, a system includes a processor and a memory coupled to the processor and storing instructions to direct the processor to: (1) receive at least one patient note from an EMR system as a source text narrative; (2) derive lexical chains corresponding to themes in the source text narrative; (3) score the lexical chains with respect to a medical taxonomy to identify higher scoring lexical chains among the lexical chains; (4) score sentences in the source text narrative with respect to the higher scoring lexical chains to identify higher scoring sentences among the sentences; and (5) create a textual summary of the source text narrative from the higher scoring sentences.

In some embodiments, a system includes a processor and a memory coupled to the processor and storing instructions to direct the processor to: for a first medical sub-domain, (1) apply NLP to narratives specific to the first medical sub-domain to extract words from the narratives; (2) compare the extracted words to a medical taxonomy to assign greater weights to words having matches to the medical taxonomy; (3) compare the extracted words to a taxonomy for a second medical sub-domain to reduce weights of words having matches to the taxonomy for the second medical sub-domain; and (4) create a taxonomy for the first medical sub-domain by arranging the extracted words according to their weights.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1: Syntax to semantics.

FIG. 2: Deriving concepts from semantics.

FIG. 3: Deriving inferences.

FIG. 4: NLP stack.

FIG. 5: Technology stack.

FIG. 6: Linguistically relevant theme derivation.

FIG. 7: Modifying theme derivation based on domain specificity.

FIG. 8: Sub-domain-specific theme derivation.

FIG. 9: Example screenshot.

FIG. 10: Example screenshot.

FIG. 11: Example screenshot.

FIG. 12: Example screenshot.

FIG. 13: Example screenshot.

FIG. 14: Example screenshot.

FIG. 15: Network environment.

FIG. 16: Computing device.

### DETAILED DESCRIPTION

A major source of information available in EMR systems are free text patient notes documenting patient care. Managing this information is time-consuming for healthcare providers. Patient notes for an individual patient can be quite voluminous, especially for patients suffering from more complex and long-term health problems. Knowing a medical history of a patient is important for a doctor, but scanning through patient notes consumes precious time that could be better spent treating the patient. Summarization of patient notes can assist healthcare providers in quickly and efficiently obtaining an overview of relevant information from the patient notes.

Embodiments of this disclosure are directed to a system and a method to create medically relevant and contextualized summaries of patient notes from an EMR system by using a modeling approach based on Natural Language Processing (NLP). In some embodiments, NLP is used to automatically create a text summary that is refined and contextualized to a medical domain by processing against a medical taxonomy based on medical and health-related terms and relationships between the terms. Further, in some embodiments, a text summary is further refined and contextualized to a specific medical sub-domain, such as chronic obstructive pulmonary disease (COPD) or angina, by processing against a medical sub-domain taxonomy. Unlike a purely linguistic text summarization, summarization according to some embodiments applies bias or greater weights towards medical and health-related terms relevant to a medical domain or sub-domain, so as to extract information that is more relevant for patient care in the context of the medical domain or sub-domain.

Some embodiments are implemented as a system, which provides a user interface accessed from a computing device, such as a tablet computer, a smart phone, another handheld or mobile device, or a personal computer, and is accessible by doctors, nurses and other medical practitioners. In some embodiments, the user interface allows user selection of a particular context, and, in response to selection of the context, the user interface displays a text summary that is specific for the selected context. For example, a “Standard View” in the user interface displays a text summary of patient notes that is contextualized in a general sense of a medical domain, while selecting a sub-domain view of “Intensive Care Unit (or ICU)” or “Out Patient” modifies the content of a summarized narrative based on what is more relevant to that sub-domain.

### I. Natural Language Processing (NLP)

In some embodiments, NLP is used to extract concepts from free-form text. Specifically, NLP can be applied to patient notes to derive primary inferences about the health and well-being of a patient. NLP can be used to identify core concepts and relationships between these core concepts. Once the core concepts are identified and their relationships established, these results can then be used as a seed to further extract secondary and tertiary inferences to derive an assessment of the patient's overall status.

In some embodiments, NLP is used to create a text summary of patient notes, such as based on textual and tabular information available within a Notes Section of an EMR system. By way of overview, the below first provides an explanation of the creation of text summaries using solely linguistic considerations, followed by an explanation of refining and contextualization of text summaries to a medical domain or a sub-domain.

### II. NLP-Based Summarization

In some embodiments, an NPL-based summarization can be implemented with the following operations:
1: Process targeted source of medical information, such as in the form of narratives and laboratory results to extract entities (concepts)
2: Create syntactic map of entities as nodes
3: Represent each node as a seed with syntactic association

In some embodiments, an NPL-based summarization can operate based on a semantic model of a textual source, which semantic model can be stored in a database. The semantic model can be created using the following operations:
1: Scan through text one word at a time
2: Create information building blocks (for example, page, paragraph, sentence, and so forth)
3: Assign parts of speech to entities (for example, object, subject, predicate, argument 1, argument 2, and so forth)
4: Assign logical labels to entities (for example, named entities, person name, company name, address, designation, place names, product names, time reference, geographical reference action verbs, and so forth)
5: Create n-tuples of entities (for example, 2-tuples, 3-tuples, 4-tuples, 5-tuples, and so forth) capturing syntactic association
6: Create inference based on NLP and seed knowledge scraped from other semantic databases
7: Repeat 1-6. Create a database of n-tuples

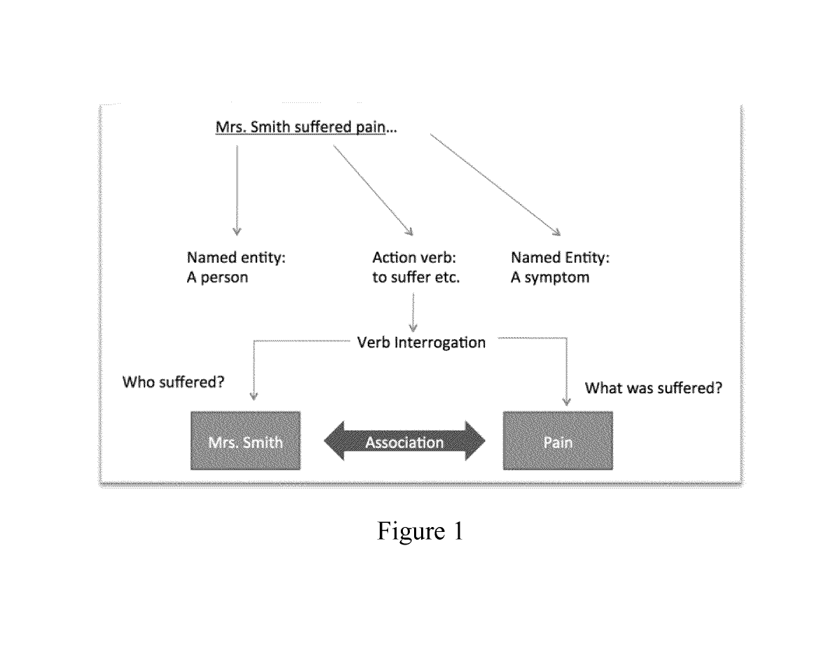

FIG. 1 is an example to illustrate how semantics can be derived from syntax. In this example, a sentence can be mined to associate “meaning” as a syntactic association between two entities (concepts)—this association, in turn, can be exploited to derive further inferences as actionable intelligence.

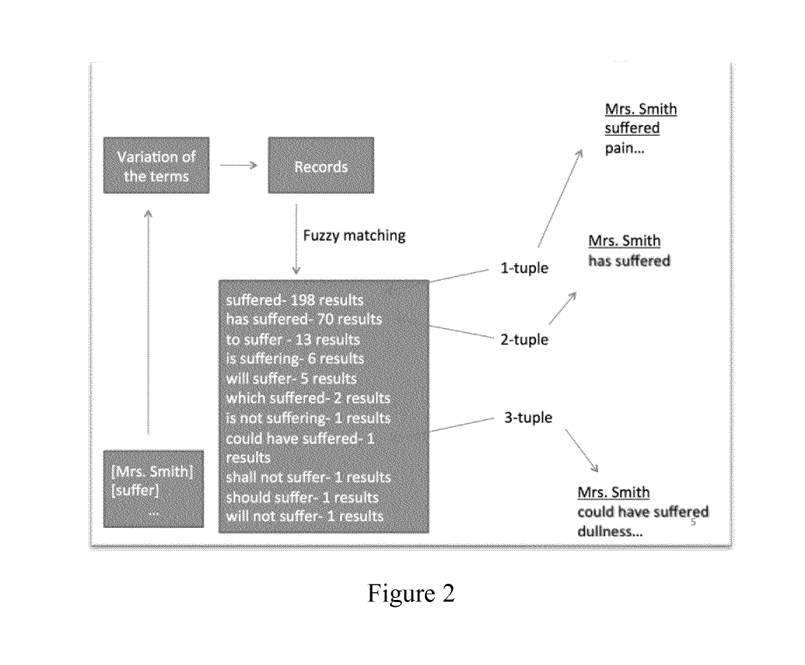

FIG. 2 is an example to illustrate that concepts derived in a previous operation can be extended to infer further relationships. This example shows how NLP can be applied to extend original core concepts, which in turn extends the coverage of the concepts. This allows coverage of normal variations in language by accounting for various ways a typical concept can be stated. These variations in language can be covered within a sematic library that acts as a link between syntax and semantics.

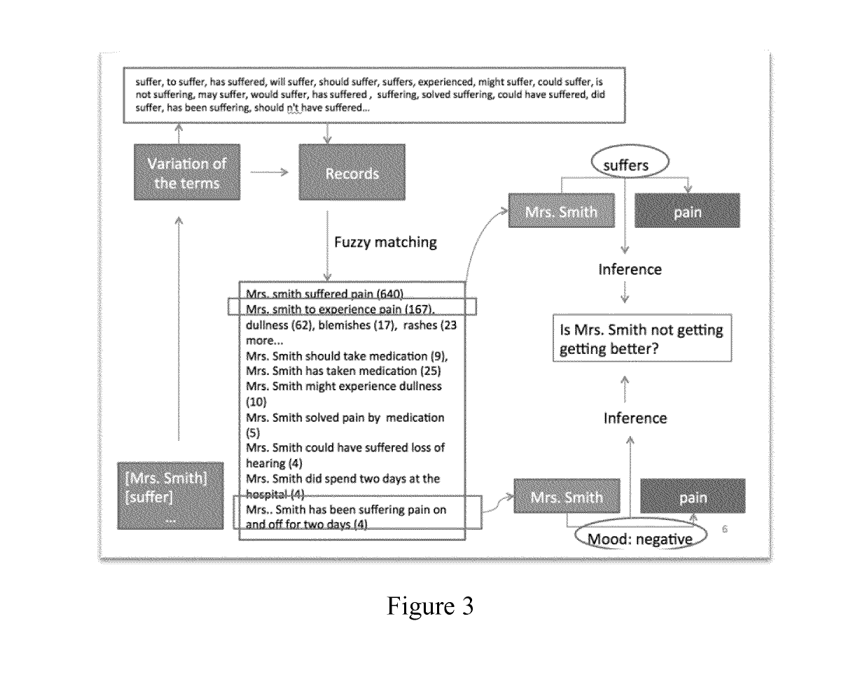

In addition to deriving semantics from syntax, NLP can be further applied to derive inferences, which can translate into actionable intelligence. FIG. 3 illustrates an example in which application of NPL to patient notes creates a summary, and further generates a ‘flag’ in the case of a discernable medical pattern.

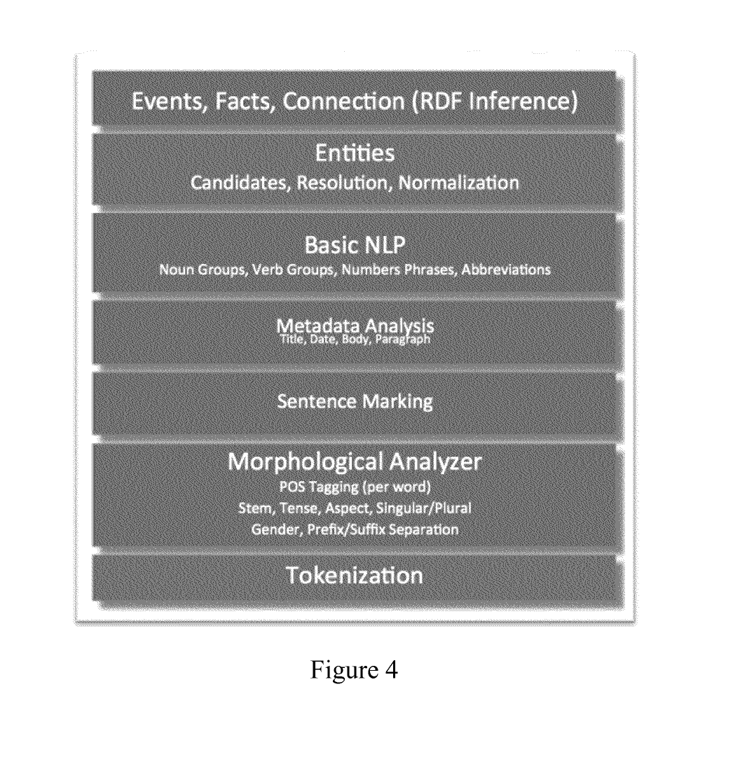

NLP-based summarization can be implemented as computer-readable instructions in the form of an NLP stack. FIG. 4 illustrates an example of an NLP stack in which various modules carry out operations as set forth in Section II above to create a semantic model of a textual source. A specific example of an NLP stack that can process natural language and break it down to component objects is the Stanford NLP Toolkit.

### III. Contextual Summarization Platform

In some embodiments, a Contextual Summarization platform is implemented to operate in conjunction with an NLP stack to create medically relevant and contextualized summaries of patient notes from an EMR system. The Contextual Summarization platform can be implemented as a technology stack, and can be accessed remotely using secured server side interfacing.

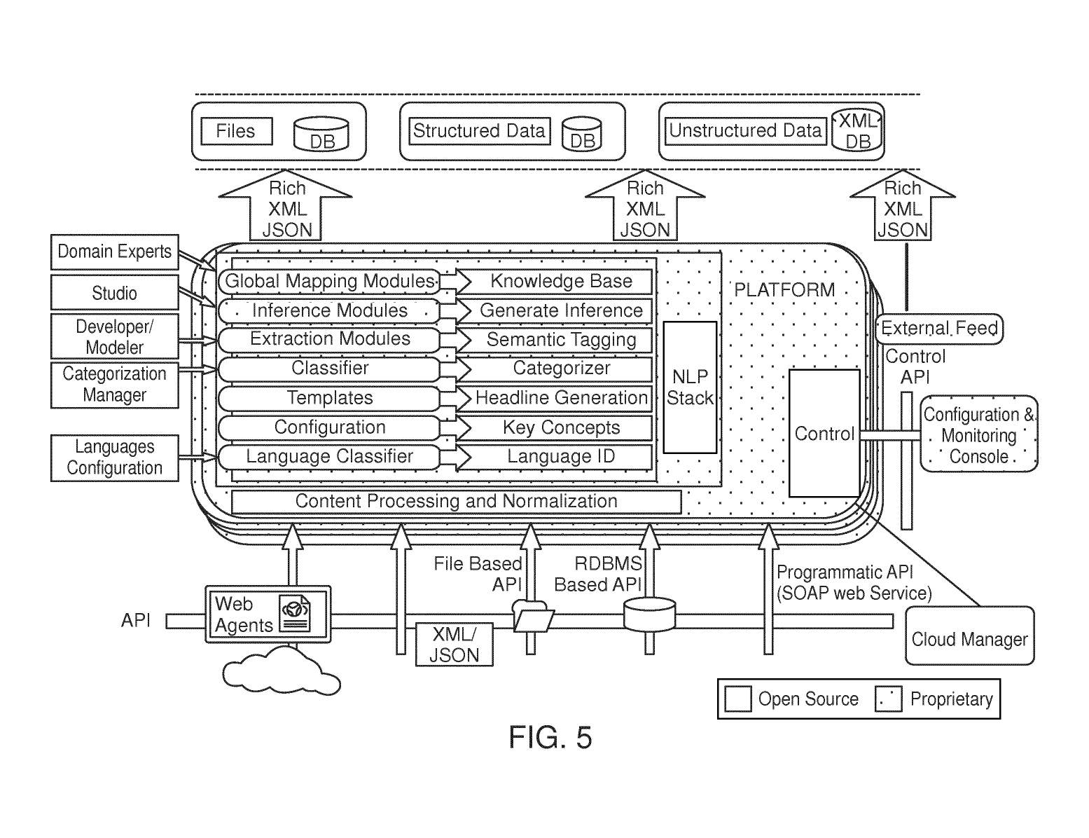

FIG. 5 illustrates an example implementation of the Contextual Summarization platform. As shown in FIG. 5, Global Mapping Modules (which includes a Contextual Summarization engine (not shown)) operate in conjunction with an NLP stack to automatically create a text summary that is refined and contextualized to a medical domain by processing against a medical taxonomy, and also operate in conjunction with the NLP stack to automatically create a text summary that is further refined and contextualized to a specific medical sub-domain by processing against a medical sub-domain taxonomy. The medical taxonomy and the medical sub-domain taxonomy form part of a knowledge base for contextualized summarization, and are derived from information obtained from domain experts. Inferences Modules operate in conjunction with the NLP stack to derive inferences, which can translate into actionable intelligence.

IVa. Linguistic Summarization

Text summarization of some embodiments is based on an extraction-based summarization approach, in which a text summary is created by selecting a subset of sentences from a source text narrative. To select a subset of sentences that represent more relevant content to be included in a summary, various possible themes of a source text narrative are derived in the form of lexical chains. By scoring the lexical chains and filtering out lower scoring lexical chains, remaining higher scoring lexical chains (also referred as “strong chains”) corresponding to core themes of the source text narrative are identified. Next, a relevance of each sentence in the source text narrative is derived by scoring the sentence with respect to the strong chains. A summary is then created by including some, or all, of higher scoring sentences, depending on a desired target length or compression ratio that is specified for the summary.

IVb. Lexical Chains

In some embodiments, a lexical chain is a representation of cohesion, in which different parts (words) of a text narrative are connected by a common theme. In other words, a lexical chain is a group or a list of semantically related words, derived by the use of, for example, co-reference, ellipses and conjunctions. The derivation of lexical chains aims to identify a relationship between words that tend to co-occur in the same or a similar lexical sense. An example is a relationship between the words “students” and “class” in the sentence: “The students are in class.” In this example, a lexical chain can be derived to include the words “students” and “class.” Another example is a relationship between the words “safe” and “combination” is the sentences: “John will open the safe . . . . He knows the combination.” In this example, a lexical chain can be derived to include the words “safe” and “combination.”

In some embodiments, derivation and scoring of lexical chains proceeds as follows. For every sentence in a source text narrative, all nouns are extracted using a Parts of Speech (POS) tagger, and all possible synonym sets (word meanings) that each noun could be part of are identified. For example, the word “bank” has a first word meaning (and is part of a first synonym set) in the sense of a financial institution, and has a second word meaning (and is part of a second synonym set) in the sense of a riverbed. Certain action verbs also can be included in the derivation of lexical chains. For every synonym set of a noun, a lexical chain is derived to include other nouns that are semantically related to that noun according to relationships in a semantic taxonomy, such as WordNet relations. Examples of WordNet relations include: (1) a synonym relation (for example, “good” and “virtuous”); (2) an antonym relation (for example, “good” and “bad”); (3) a hypernym/hyponym relation between a class and a member of the class (for example, “vehicle” and “car”); and (4) a meronym/holonym relation between a whole and a part of the whole (for example, “tree” and “leaf”).

Once lexical chains are derived, a score for each lexical chain is calculated based on a chain size and a homogeneity index of the chain, using the following scoring criterion:

where

$$Chain Size = {\sum }_{all chain entries ( ch ( i ) )} w ( ch ( i ) )$$

and represents how large the chain is and each chain entry ch(i) (noun) contributing according to how related it is to another chain entry according to its weight w(ch(i)):

w(ch(i))=relation(ch(i))/(1+distance(ch(i)))
relation(ch(i))=1, if ch(i) is a synonym
   0.7, if ch(i) is an antonym
   0.4, if ch(i) is a hypernym, holonym, meronym, or hyponym
distance(ch(i))=number of intermediate nodes in a hypernym graph for hypernyms and hyponyms, and is 0 otherwise.

A weight w(ch(i)) of each chain entry ch(i) has a value in a range of 0 to 1, and, when adding a chain entry ch(i) to a lexical chain already including two or more chain entries, the weight w(ch(i)) of the chain entry ch(i) is calculated and assigned with respect to another (earlier added) chain entry ch(j) that is most related to the chain entry ch(i), namely yielding the greatest value for the weight w(ch(i)). A first chain entry added to a lexical chain is assigned a weight value of 1. A lexical chain can include repeated instances, or duplicates, of a noun (for example, the same noun appearing in multiple instances across one or more sentences), and each repeated instance of the noun contributes towards the calculation of a chain size.

In the scoring criterion of a lexical chain, the homogeneity index of the chain is calculated as follows:

$$Homogeneity Index = 1.5 - \{ [ {\sum }_{all distinct chain entries ( ch ( i ) )} w ( ch ( i ) ) ] \text{/} Chain Size \}$$

where the summation is over all distinct chain entries (omitting duplicates), and represents how diverse are entries of the chain. A homogeneity index has a value in a range of 0.5 to 1.5, and, the greater the number of duplicates included in a lexical chain, the greater the value of the homogeneity index, while the lesser the number of duplicates included in the lexical chain, the smaller the value of the homogeneity index.

To ensure that there is no duplicate lexical chain and that no two lexical chains overlap, a single lexical chain with a highest score is selected for every noun, and the rest are discarded. Of the remaining lexical chains, “strong chains” (representing core themes) are identified as higher scoring lexical chains by applying the following filtering criterion:

Chain Score≧Average Chain Score Across Remaining Lexical Chains+0.5×Standard Deviation

IVc. Summary Creation

Once strong chains are identified for a source text narrative, the relevance of each sentence in the source text narrative is derived by scoring the sentence with respect to the strong chains. In some embodiments, a score for each sentence is calculated with respect to each strong chain using the following scoring criterion:

$$Sentence Score = w ( ch ) \times Chain Score + 2 \times [ {\sum }_{all strong chains including entries in this sentence} w ( ch ) * Chain Score ) ] / sentence length$$

where w(ch) is a weight of an entry (noun) in a strong chain that is included in the sentence, chain score is a score of the strong chain, the summation is over all strong chains including entries in the sentence, and a sentence length is a total number of words in the sentence.

A text summary is created by adding sentences to the summary, starting with the highest scoring sentences until there is no sentence remaining (which satisfies a threshold criterion, for example, a threshold score or includes at least one entry in a strong chain), or until a length of the summary reaches a target length. The target length of the summary can be related to an original length of the source narrative (for example, as a compression ratio), but can also be specified by the user.

The foregoing explanation of NLP-based identification of themes involves processing of language, without focus or contextualization to a domain or sub-domain. Therefore, resulting themes and a text summary created from the themes solely take into account a linguistic emphasis of a source text narrative, and may fail to focus on a domain-specific emphasis.

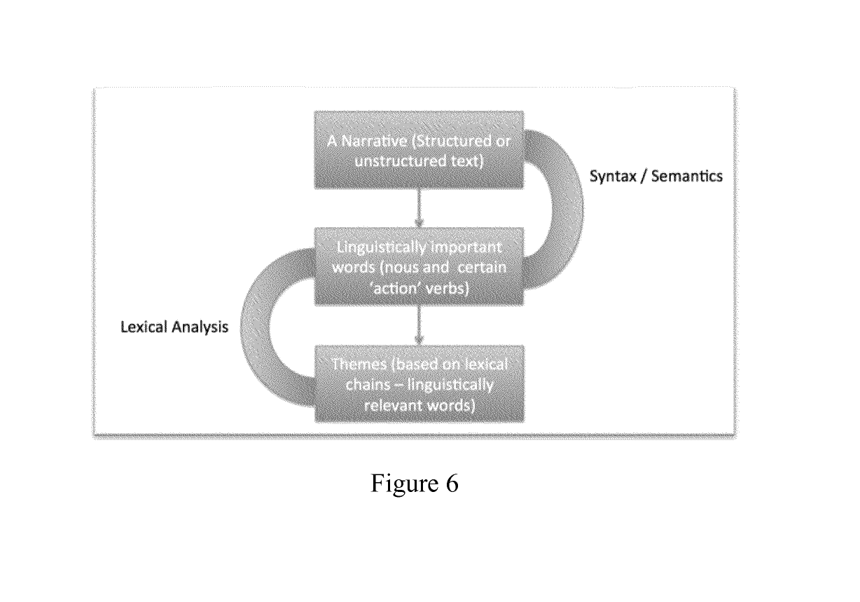

FIG. 6 illustrates an example of a linguistic processing of a source text narrative and subsequent use of lexical analysis (semantic relationships) to derive a set of lexical chains—each of which is a set of linguistically relevant words representing a theme. However, derived themes may fail to focus on a domain-specific emphasis (for example, a medical domain), since domain specificity is not incorporated in the linguistic processing.

Va. Medically or Clinically Relevant Summarization

As a refinement of linguistic processing, a text summary is contextualized to a medical domain by processing against a medical taxonomy, and applying bias or greater weights towards medical and health-related terms. In such manner, a clinical nature of patient notes from an EMR system can be accounted to create a text summary that assigns appropriate weights to both linguistic and clinical nature of the information contained within the patient notes.

Vb. Medical Domain Taxonomy

To create a text summary that is tuned to a specific domain, a mechanism is incorporated into NLP-based summarization to apply bias in the scoring of lexical chains. In some embodiments, this mechanism is implemented through the introduction of a taxonomy that is derived for a specific domain, for example, a medical domain.

A medical taxonomy can include a set of words that are associated with the medical domain and are specified or arranged in terms of their usage and application. In some embodiments, in conjunction with NLP-based extraction of linguistically relevant words (nouns and verbs) from a source text narrative, words from the source narrative are also cross-referenced against the medical taxonomy. If there is a match, then a weight of the word is multiplied by a factor, for example, in a range of 1.1 to 1.3. Because the manner in which a lexical chain is scored depends on weights of individual chain entries, this biasing effectively raises a score of a lexical chain that includes more medically relevant words. This in turn impacts the content of a text summary resulting from summarization, since the process of summarization sorts lexical chains with respect to their scores, and uses highest scoring chains as a basis of selection of sentences within the source narrative that are included in the summary.

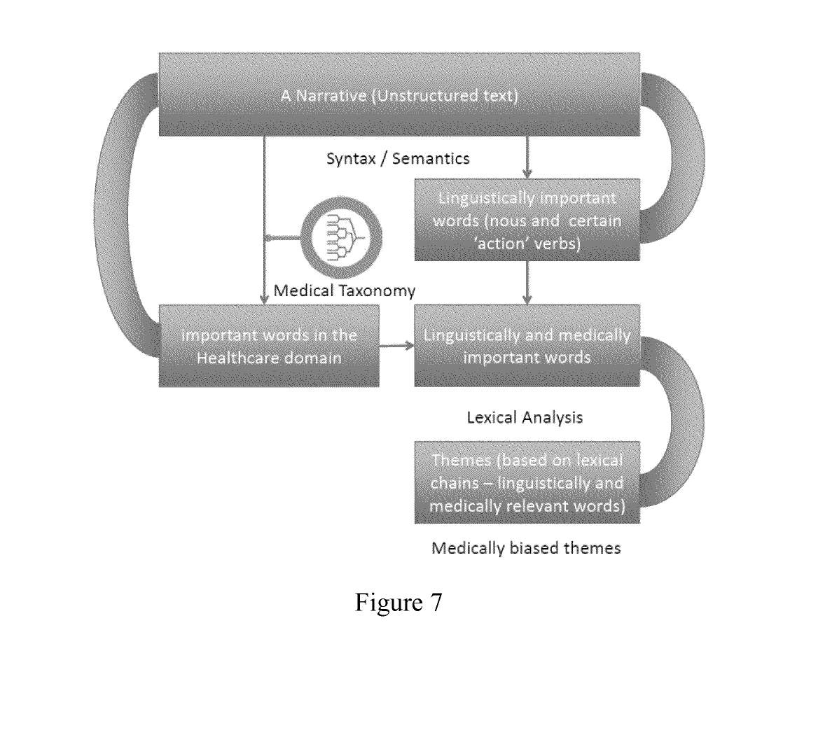

FIG. 7 illustrates an example of the use of a medical taxonomy to apply a bias towards medically relevant themes.

Vc. Lexical Chains

To account for possible matches to a medical taxonomy, the calculation of a score for each lexical chain is modified based on the following scoring criterion:

where

$$Chain Size = {\sum }_{all chain entries ( ch ( i ) )} w ( ch ( i ) )$$

and represents how large the chain is and each chain entry ch(i) (noun) contributing according to its weight w(ch(i)):

w(ch(i))=[relation(ch(i))×domain scoring(ch(i))]/(1+distance(ch(i)))
domain scoring (ch(i))=1.2 if there is a match in the medical taxonomy
   1.0 if there is no match in the medical taxonomy
relation(ch(i))=1, if ch(i) is a synonym
   0.7, if ch(i) is an antonym
   0.4, if ch(i) is a hypernym, holonym, meronym, or hyponym
distance(ch(i))=number of intermediate nodes in a hypernym graph for hypernyms and hyponyms, and is 0 otherwise.

$$Homogeneity Index = 1.5 - \{ [ {\sum }_{all distinct chain entries ( ch ( i ) )} w ( ch ( i ) ) ] \text{/} Chain Size \}$$

Once scores are calculated for lexical chains with appropriate bias, strong chains are identified, and sentences are selected for inclusion in a text summary similarly as explained above in Section IV.

VIa. Contextualized Summarization Relevant to Medical Sub-Domains

As a further refinement of linguistic processing, a text summary is contextualized to target one or more specific medical sub-domains. In general, sub-domains are domains within a general medical domain. Each medical sub-domain can correspond to a specific clinical encounter, where the nature of clinical encounters can be varied, such as a specific medical condition, such as COPD or angina, or a specific type of clinical intervention, such as surgery or hospitalization, or a specific setting of patient interaction, such as an intensive care unit (ICU) or an out-patient appointment. Sub-domain contextualization can be attained by processing against a medical sub-domain taxonomy, and applying bias or greater weights towards medical and health-related terms that are distinctly relevant for a medical sub-domain. In such manner, a specifically targeted text summary can be created that is relevant for a clinical encounter.

VIb. Medical Sub-Domain Taxonomy

In some embodiments, for medical sub-domains of interest, sub-domain definitions are automatically created in the form of medical sub-domain taxonomies using the following operations:
1: Apply NLP on clinical treatment guidelines for a medical sub-domain (for example, “Care Guidelines” for a specific medical condition). This operation extracts linguistically relevant words (nouns and certain action verbs), producing a generic and mixed “bag of words.” Other sub-domain-specific narratives can be used in place of, or in conjunction with, clinical treatment guidelines.
2: Compare the extracted words against a medical domain taxonomy. Each extracted word that matches the medical taxonomy is assigned a higher weight. This operation results in some of the extracted words within the “bag of words” to have greater weights, effectively creating multiple, weighted “bag of words”—words within which have the same weight.
3: Repeat 1 and 2 for other sub-domains. This results in weighted “bag of words” for each sub-domain.
4: Compare extracted words for the different sub-domains. For example, assuming n sub-domains—sub-domains to sub-domainₙ, for each word, there can be no matches or there can be up to a maximum of (n−1) matches across the sub-domains. Based on the number of matches, a weight of each word is reduced in opposite relation (for example, opposite proportion) to the number of matches. This operation allows the identification of words that are common across multiple sub-domains and reduce their effect or weight on the sub-domain definitions.
5: For each sub-domain, create a sub-domain taxonomy where words with greater weights are placed closer to a root, and words with smaller weights are placed farther from the root. This results in a sub-domain taxonomy where each word is arranged or sorted by weight in relation to how unique or distinct that word is with respect to the corresponding sub-domain.

The creation of sub-domain definitions in the form of medical sub-domain taxonomies can be performed according to an unsupervised training approach, although embodiments encompassing supervised training approaches are also contemplated.

In some embodiments, in conjunction with NLP-based extraction of linguistically relevant words (nouns and verbs) from a source text narrative, and in conjunction with cross-referencing of words from the source narrative against the medical taxonomy, words from the source narrative are also cross-referenced against a medical sub-domain taxonomy. If there is a match, then a weight of the word is multiplied by a factor, for example, in a range of 1.2 to 1.4. Because the manner in which a lexical chain is scored depends on weights of individual chain entries, this biasing effectively raises a score of a lexical chain that includes more sub-domain-specific words. This in turn impacts the content of a text summary resulting from summarization, since the process of summarization sorts lexical chains with respect to their scores, and uses highest scoring chains as a basis of selection of sentences within the source narrative that are included in the summary.

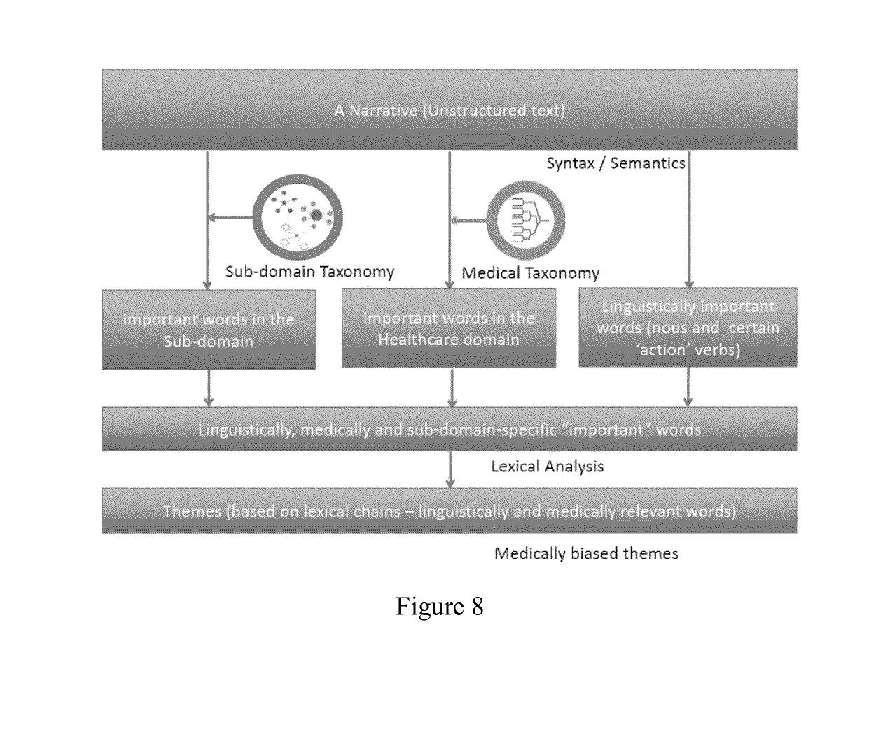

FIG. 8 illustrates an example of the use of a medical sub-domain taxonomy to apply a bias towards sub-domain-specific themes.

VIc. Lexical Chains

To account for possible matches to a medical taxonomy and a medical sub-domain taxonomy, the calculation of a score for each lexical chain is modified based on the following scoring criterion:

Chain Score=Chain Size×Homogeneity Index

where

$$Chain Size = {\sum }_{all chain entries ( ch ( i ) )} w ( ch ( i ) )$$

and represents how large the chain is and each chain entry ch(i) (noun) contributing according to its weight w(ch(i)):

w(ch(i))=[relation(ch(i))×domain scoring(ch(i))×sub-domain scoring(ch(i))]/(1+distance(ch(i)))
domain scoring (ch(i))=1.2 if there is a match in the medical taxonomy
   1.0 if there is no match in the medical taxonomy
sub-domain scoring (ch(i))=1.2 if there is a match in the medical sub-domain taxonomy
   1.0 if there is no match in the medical sub-domain taxonomy
relation(ch(i))=1, if ch(i) is a synonym
   0.7, if ch(i) is an antonym
   0.4, if ch(i) is a hypernym, holonym, meronym, or hyponym
distance(ch(i))=number of intermediate nodes in a hypernym graph for hypernyms and hyponyms, and is 0 otherwise.

$$Homogeneity Index = 1.5 - \{ [ {\sum }_{all distinct chain entries ( ch ( i ) )} w ( ch ( i ) ) ] \text{/} Chain Size \}$$

Once scores are calculated for lexical chains with appropriate bias, strong chains are identified, and sentences are selected for inclusion in a text summary similarly as explained above in Section IV.

### VII. Example Screenshots

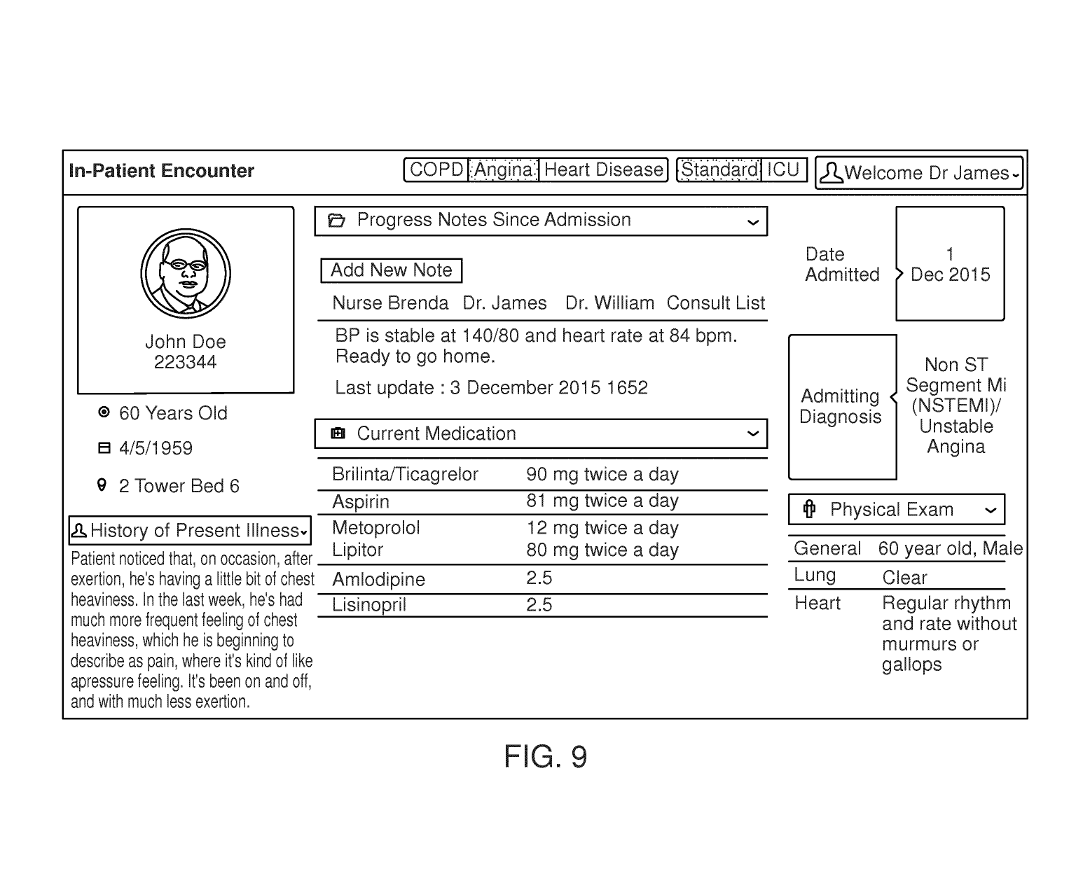

FIGS. 9 through 14 illustrate example screenshots of a user interface that can be provided by a Contextualized Summarization platform of some embodiments of this disclosure.

FIG. 9 shows a screenshot of an example web page in which a user can access functionality of the Contextualized Summarization platform. As shown in FIG. 9, the interface allows the user to specify a “Standard View” in the interface displays a text summary of patient notes for a specific patient that is contextualized in a general sense of a medical domain, and, as an option, to further specify a sub-domain view of “COPD,” “Angina,” “Heart Disease,” or “ICU” in which the interface displays a text summary of the patient notes for the patient that is further contextualized to a specified medical sub-domain. The various views are provided by way of example, and other views can be included or customized according to the user's interests. In the example of FIG. 9, the “Standard View” and the sub-domain view of “Angina” are specified, triggering creation of text summaries by processing against both a medical taxonomy and a sub-domain taxonomy for angina.

As shown in FIG. 9, the interface provides tabs of “Nurse Brenda,” “Dr. James,” and “Dr. William” corresponding to different healthcare providers attending to the patient since admission, and, upon selection of one of the tabs, the interface displays a text summary of narratives entered by a specified healthcare provider since admission of the patient. Here, the tab of “Nurse Brenda” is specified, narrative entries by “Nurse Brenda” are selected as a source text narrative, and a contextualized text summary of the selected source narrative is created and displayed.

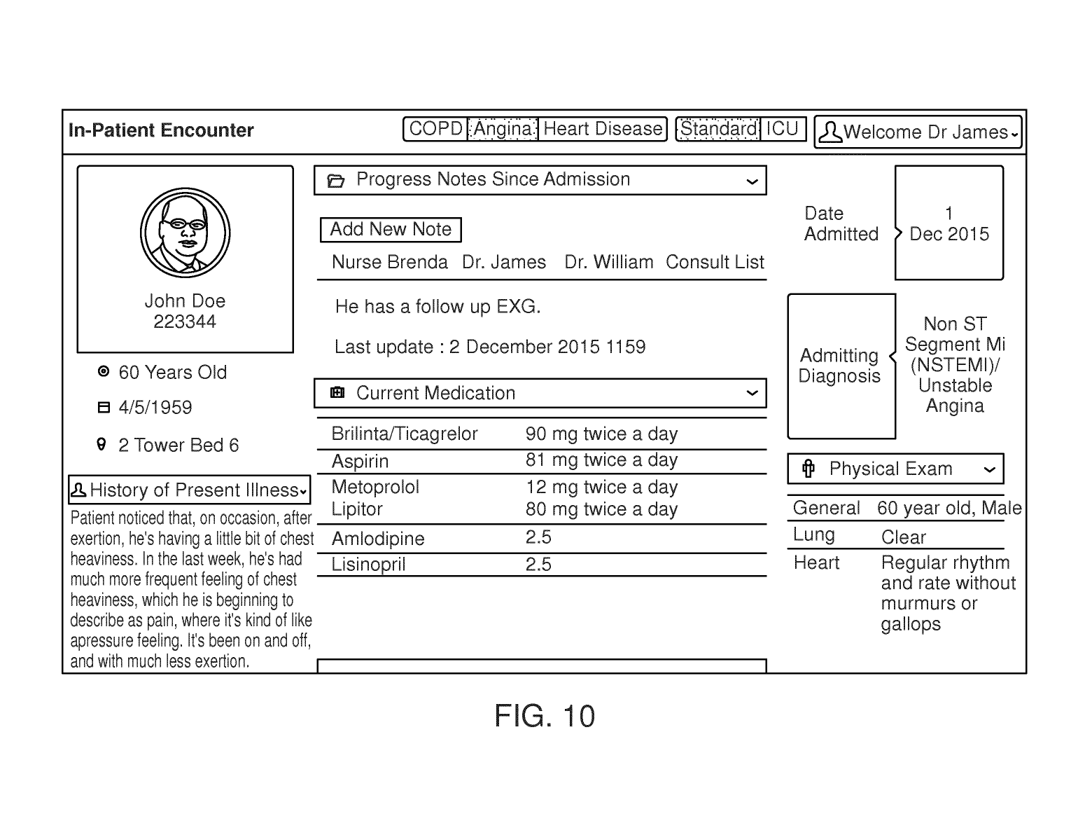

Turning next to FIG. 10, the tab of “Dr. James” is specified, narrative entries by “Dr. James” are selected as a source text narrative, and a contextualized text summary of the selected source narrative is created and displayed.

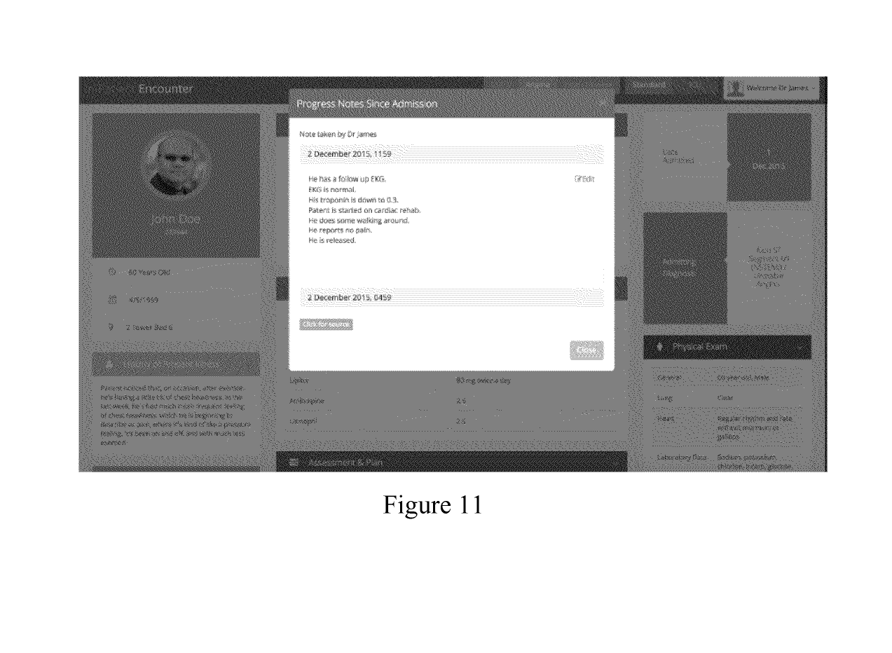

Turning next to FIG. 11, narrative entries by “Dr. James” (which is the source narrative from which the contextualized summary of FIG. 10 is created) are displayed. By comparing FIGS. 10 and 11, it can be observed that a first sentence of a narrative entry of a particular date and time is extracted for inclusion in the summary.

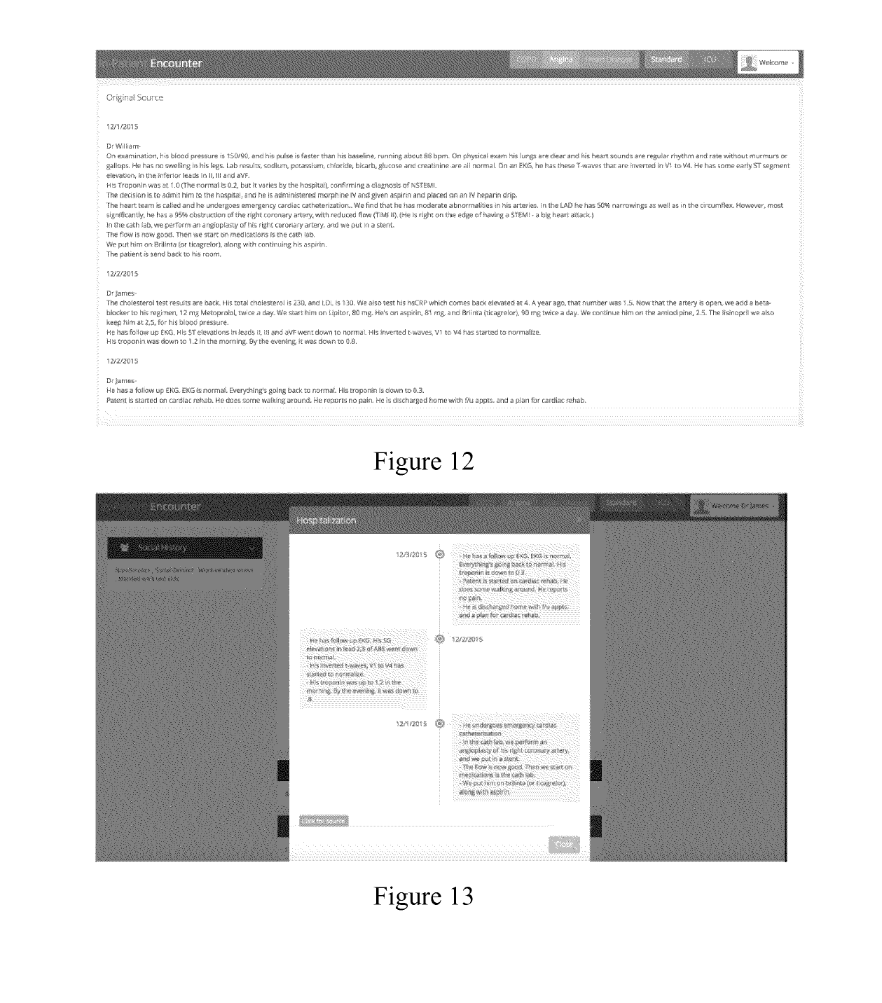

Upon clicking on a “Click for Source” button, a collection of narratives entered by all attending healthcare providers is displayed, as shown in FIG. 12. The narratives are arranged chronologically by date since admission of the patient.

Using the chronologically arranged narratives of all attending healthcare providers as a source text narrative, a contextualized and chronologically arranged text summary of the source narrative is created and displayed, as shown in FIG. 13.

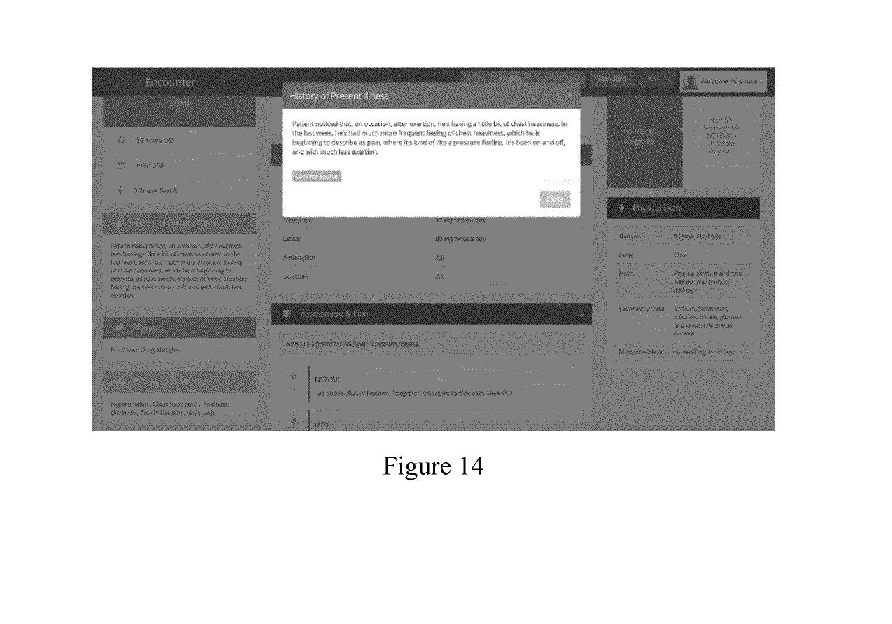

In addition to displaying a text summary of narratives entered since admission of the patient, the interface includes functionality to display a text summary of patient notes prior to admission. Referring to FIG. 14, a pop-up window of “History of Present Illness” displays a text summary that is contextualized by processing the prior patient notes against both the medical taxonomy and the sub-domain taxonomy for angina.

### VIII. Features and Benefits

By way of summary, some embodiments of this disclosure include one or more of the following features and benefits:
A system and a method to create medically relevant and contextualized summaries of patient notes from an EMR system by using a modeling approach based on NLP.
Ability to automatically create sub-domain-specific taxonomies from sub-domain-specific narratives.
Ability to create text summaries for virtually any domain. Although some embodiments are explained in the context of a medical domain, other embodiments encompass text summarization in the context of domains other than the medical domain, for example, a financial domain, a scientific domain, a sports domain, a legal domain, and so forth.
Ability to adapt to any number of domains or sub-domains.
Ability to create text summarizes of different levels of specificity based on context.
Ability to automatically create sub-domain-specific taxonomies without supervised training.
Ability to adapt to different languages, where an NLP stack is available for a language of interest. Other modules and processing can be language neutral.
Ability to be implemented in any hardware or software system.
Ability to be accessed from a variety of computing devices, including handheld or mobile devices.

### IX. Network Environment and Computing Device Implementations

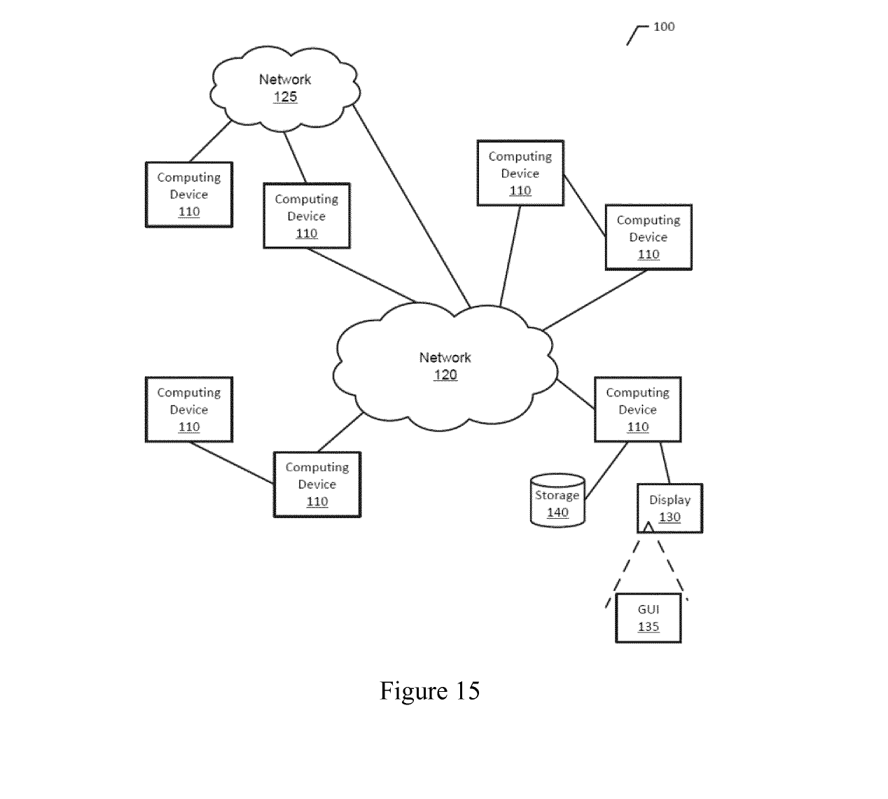

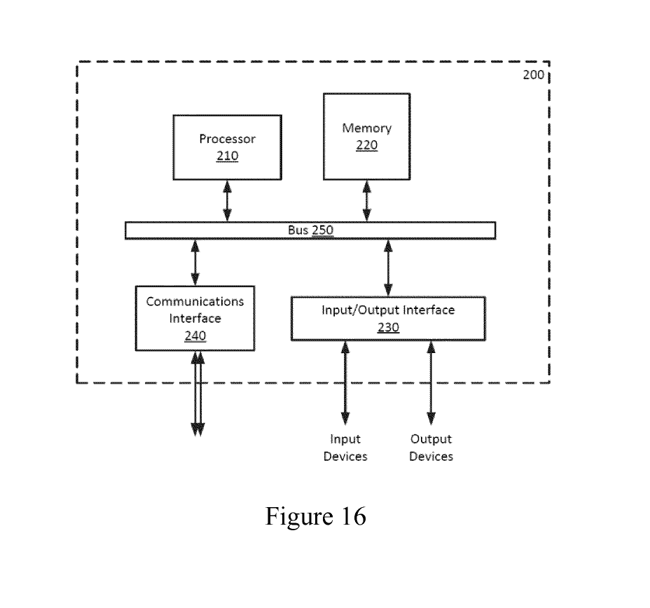

FIG. 15 illustrates an example of a network environment 100 in which a Contextual Summarization platform of some embodiments can be implemented. As shown, computing devices 110 may communicate with each other directly, through another computing device 110, through one network 120 or 125, or through a combination of networks 120, 125. Computing devices 110 are devices including a combination of hardware and software (including firmware and hard-wired software), in which processing circuitry such as a processor executes instructions that direct the processor to perform functionality. Computing devices 110 are described in more detail with respect to FIG. 16. Functionality of a Contextual Summarization platform of some embodiments can be implemented within one component shown in FIG. 15, or across multiple components shown in FIG. 15.

Networks 120, 125 each represent one or more public or private networks. For example, one of networks 120, 125 may represent a local area network (LAN), a home network in communication with a LAN, a LAN in communication with a wide area network (WAN) such as the Internet, a WAN, or other networks, or a combination of networks. Portions of one or more networks 120, 125 may be wired, and portions of one or more networks 120, 125 may be wireless. Further, networks 120, 125 may include one or more of telephone networks, cellular networks, or broadband networks. Communication through the networks 120, 125 may be made using standard or proprietary protocols useful for the associated network.

One or more computing devices 110 in the network environment 100 include a display 130 for providing information to a user of the computing device 110, and a graphical user interface 135 for interaction with the user. Input devices (not shown) allow the user to input information for the user interaction. In some embodiments, display 130 is a touch screen display, and is correspondingly also an input device. Other examples of input devices include a mouse, a microphone, a camera, and a biometric detector.

One or more computing devices 110 in the network environment 100 include an external storage 140, which represents one or more memory devices for storing information. Storage 140, for example, is a mass storage, and may include one or more databases. Storage 140 may be dedicated to one or more computing devices 110 (which may be co-located with storage 140 or in communication with storage 140 over one or more networks 120, 125), or may be non-dedicated and accessible to one or more computing devices 110 (locally or by way of one or more networks 120, 125).

FIG. 16 illustrates an example of a computing device 200 that includes a processor 210, a memory 220, an input/output interface 230, and a communications interface 240. A bus 250 provides a communication path between two or more of the components of computing device 200. The components shown are provided by way of example and are not limiting. Computing device 200 may have additional or fewer components, or multiple of the same component.

Processor 210 represents one or more of a microprocessor, microcontroller, an application-specific integrated circuit (ASIC), and a field-programmable gate array (FPGA), along with associated logic.

Memory 220 represents one or both of volatile and non-volatile memory for storing information. Examples of memory include semiconductor memory devices such as EPROM, EEPROM, RAM, and flash memory devices, discs such as internal hard drives, removable hard drives, magneto optical, CD, DVD, and Blu-ray discs, memory sticks, and the like.

Portions of the functionality of a Contextual Summarization platform of some embodiments can be implemented as computer-readable instructions in memory 220 of computing device 200, executed by processor 210.

Input/output interface 230 represents electrical components and optional instructions that together provide an interface from the internal components of computing device 200 to external components. Examples include a driver integrated circuit with associated programming.

Communications interface 240 represents electrical components and optional instructions that together provide an interface from the internal components of computing device 200 to external networks, such as network 120 or network 125 (FIG. 15).

Bus 250 represents one or more connections between components within computing device 200. For example, bus 250 may include a dedicated connection between processor 210 and memory 220 as well as a shared connection between processor 210 and multiple other components of computing device 200.

Some embodiments of this disclosure relate to a non-transitory computer-readable storage medium having computer code or instructions thereon for performing various computer-implemented operations. The term “computer-readable storage medium” is used to include any medium that is capable of storing or encoding a sequence of instructions or computer code for performing the operations, methodologies, and techniques described herein. The media and computer code may be those specially designed and constructed for the purposes of the embodiments of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as ASICs, programmable logic devices (PLDs), and ROM and RAM devices.

Examples of computer code include machine code, such as produced by a compiler, and files containing higher-level code that are executed by a processor using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computing device) to a requesting computer (e.g., a client computing device or a different server computing device) via a transmission channel. Another embodiment of the disclosure may be implemented in hardwired circuitry in place of, or in combination with, processor-executable software instructions.

As used herein, the singular terms “a,” “an,” and “the” may include plural referents unless the context clearly dictates otherwise. Thus, for example, reference to an object may include multiple objects unless the context clearly dictates otherwise.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations are not a limitation of the disclosure.

What is claimed is:

1. A computer-implemented method comprising:
receiving at least one patient note from an electronic medical record (EMR) system as a source text narrative;
deriving lexical chains corresponding to themes in the source text narrative;
scoring the lexical chains with respect to a medical taxonomy to identify higher scoring lexical chains among the lexical chains;
scoring sentences in the source text narrative with respect to the higher scoring lexical chains to identify higher scoring sentences among the sentences; and
creating a textual summary of the source text narrative from the higher scoring sentences.

2. The computer-implemented method of claim 1, further comprising:
receiving a user specification of a medical sub-domain,
wherein scoring the lexical chains further includes scoring the lexical chains with respect to a taxonomy for the medical sub-domain.

3. The computer-implemented method of claim 2, further comprising creating the taxonomy for the medical sub-domain by applying Natural Language Processing (NLP) to narratives specific to the medical sub-domain.

4. The computer-implemented method of claim 1, further comprising:
delivering the textual summary for display at a computing device.

5. A system comprising:
a processor; and
a memory coupled to the processor and storing instructions to direct the processor to:
receive at least one patient note from an EMR system as a source text narrative;
derive lexical chains corresponding to themes in the source text narrative;
score the lexical chains with respect to a medical taxonomy to identify higher scoring lexical chains among the lexical chains;
score sentences in the source text narrative with respect to the higher scoring lexical chains to identify higher scoring sentences among the sentences; and
create a textual summary of the source text narrative from the higher scoring sentences.

6. The system of claim 5, wherein the memory further stores instructions to direct the processor to:
receive a user specification of a medical sub-domain,
wherein the instructions to score the lexical chains include instructions to score the lexical chains with respect to a taxonomy for the medical sub-domain.

7. The system of claim 6, wherein the memory further stores instructions to direct the processor to create the taxonomy for the medical sub-domain by applying NLP to narratives specific to the medical sub-domain.

8. The system of claim 5, wherein the memory further stores instructions to direct the processor to:
deliver the textual summary for display at a computing device.

9. A system comprising:
a processor; and
a memory coupled to the processor and storing instructions to direct the processor to:
for a first medical sub-domain,
apply NLP to narratives specific to the first medical sub-domain to extract words from the narratives;
compare the extracted words to a medical taxonomy to assign greater weights to words having matches to the medical taxonomy;
compare the extracted words to a taxonomy for a second medical sub-domain to reduce weights of words having matches to the taxonomy for the second medical sub-domain; and
create a taxonomy for the first medical sub-domain by arranging the extracted words according to their weights.

10. The system of claim 9, wherein the memory further stores instructions to direct the processor to:
receive at least one patient note from an EMR system as a source text narrative;
receive a user specification of the first medical sub-domain;
derive lexical chains corresponding to themes in the source text narrative;
score the lexical chains with respect to the medical taxonomy and with respect to the taxonomy for the first medical sub-domain to identify higher scoring lexical chains among the lexical chains for the first medical sub-domain;
score sentences in the source text narrative with respect to the higher scoring lexical chains for the first medical sub-domain to identify higher scoring sentences among the sentences for the first medical sub-domain; and
create a textual summary for the first medical sub-domain from the higher scoring sentences for the first medical sub-domain.

11. The system of claim 10, wherein the memory further stores instructions to direct the processor to:
receive a user specification of the second medical sub-domain;
score the lexical chains with respect to the medical taxonomy and with respect to the taxonomy for the second medical sub-domain to identify higher scoring lexical chains among the lexical chains for the second medical sub-domain;
score sentences in the source text narrative with respect to the higher scoring lexical chains for the second medical sub-domain to identify higher scoring sentences among the sentences for the second medical sub-domain; and
create a textual summary for the second medical sub-domain from the higher scoring sentences for the second medical sub-domain.
